(19) United States
(12) Patent Application Publication
(10) Pub. No.: US 2008/0041234 A1
(43) Pub. Date: Feb. 21, 2008

(54) Machine for Percolating a Beverage from Powdered Material in a Container

(76) Inventor: Virginio Cortese, Torino (IT)

Correspondence Address: LADAS & PARRY, 26 WEST 61ST STREET, NEW YORK, NY, 10023, US

(21) Appl. No.: 11/597,732

(22) PCT Filed: May 24, 2005
(86) PCT No.: PCT/EP05/52368

§ 371 Date: Aug. 17, 2007

(30) Foreign Application Priority Data
May 25, 2004 (IT) TO2004A000351

(51) Int. Cl. A47J 31/44

(52) U.S. Cl. 99/290

(57) ABSTRACT

A machine for percolating a beverage from a powdered material in a container, the machine having a sprinkler located along a horizontal first axis; and a percolating member, which has two opposite percolating cups for housing respective containers, and is mounted to rotate about a horizontal second axis, crosswise to the first axis and movable therealong, to selectively position each percolating cup in a first loading position in which the percolating cup faces vertically upwards, in a second position coaxial with and facing the sprinkler, and in a third unloading position in which the percolating cup faces downwards.

### TECHNICAL FIELD

The present invention relates to a machine for percolating a beverage from powdered material in a container.

More specifically, the present invention relates to a percolating machine of the type disclosed in WO-A-01/76430, that is a machine for percolating a beverage from powdered material in a container, the machine comprising pressurized-hot-water dispensing means having a first axis, which is a horizontal axis; a percolating member facing the hot-water dispensing means and comprising two opposite percolating cups for housing respective said containers; first actuating means for moving the pressurized-hot-water dispensing means along the first horizontal axis and to and from a fluidtight engaged position with the percolating member to define a percolating chamber therewith; second actuating means for rotating the percolating member about a second axis, which is a horizontal axis perpendicular to the first axis, so as to selectively position each percolating cup in a first loading position in which said percolating cup faces vertically upwards, in a second position in which said percolating cup is coaxial with the first axis and can be set to said fluidtight engaged position, and in a third unloading position in which said percolating cup faces downwards; and discharge means communicating with the percolating chamber to expel said beverage.

Though the machine according to the present invention can be used for percolating any type of beverage produced by feeding pressurized hot water through a relative powdered or substantially anhydrous granulated food substance in a container, specific reference is made, purely by way of example, in the following description to a machine for producing a coffee beverage using a container containing a respective measure of ground coffee.

### BACKGROUND ART

In known machines of the type described above, the second axis is a fixed axis, and rotation of the percolating member about the second axis without interfering with the pressurized-hot-water dispensing means normally requires arranging the second axis at such a distance from the pressurized-hot-water dispensing means that a gap of some millimeters normally exists between the pressurized-hot-water dispensing means and the percolating cup arranged in the aforementioned second position. This gap is eliminated by operating the first actuating means which, as disclosed in EP-B-0671141, are normally hydraulic actuating means operated by the same pressurized hot water used for percolation and fed toward the percolating chamber by means of an electro-magnetic pump or the like.

In general, the size of the aforementioned gap is such that the quantity of pressurized hot water used to bring the pressurized-hot-water dispensing means to the fluidtight engaged position with the percolating member is at least equal to the quantity of pressurized hot water then used for percolation.

The above means that the aforementioned gap at least doubles the percolation time and the energy consumption, and normally involves using more powerful pumps or more pumps.

### DISCLOSURE OF INVENTION

To eliminate the above drawback, the present invention provides a machine for percolating a beverage from powdered material in a container, as claimed in claim 1 and, preferably, in any one of the following Claims depending directly or indirectly on claim 1.

### BRIEF DESCRIPTION OF THE DRAWINGS

A number of non-limiting embodiments of the invention will be described by way of example with reference to the accompanying drawings, in which:

FIG. 1 shows a preferred embodiment of a hydraulic system of the machine according to the present invention;

FIGS. 2 to 5 show schematic side views, with parts in section and parts removed for clarity, and in respective different operating configurations, of a machine featuring the FIG. 1 hydraulic system and constituting a first preferred embodiment of the machine according to the present invention;

FIGS. 6 to 8 show schematic side views, with parts in section and parts removed for clarity, and in respective different operating configurations, of a machine featuring the FIG. 1 hydraulic system and constituting a second preferred embodiment of the machine according to the present invention;

FIG. 9 shows a plan view of the FIG. 6-8 machine in the FIG. 7 operating configuration;

FIG. 10 shows a section along line X-X in FIG. 9;

FIG. 11 shows a section along line XI-XI in FIG. 10.

### BEST MODE FOR CARRYING OUT THE INVENTION

Number 1 in the accompanying drawings indicates as a whole a machine for making espresso coffee from a container 2 of ground coffee.

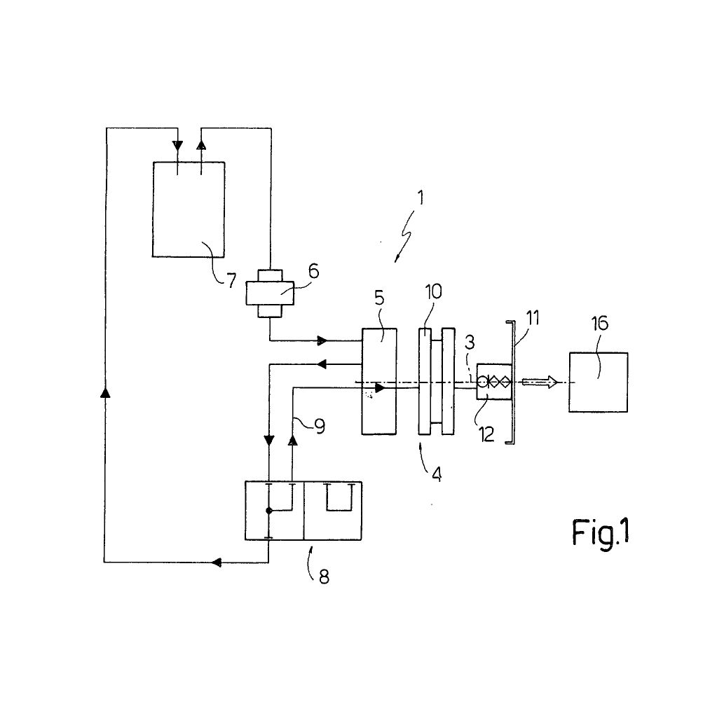

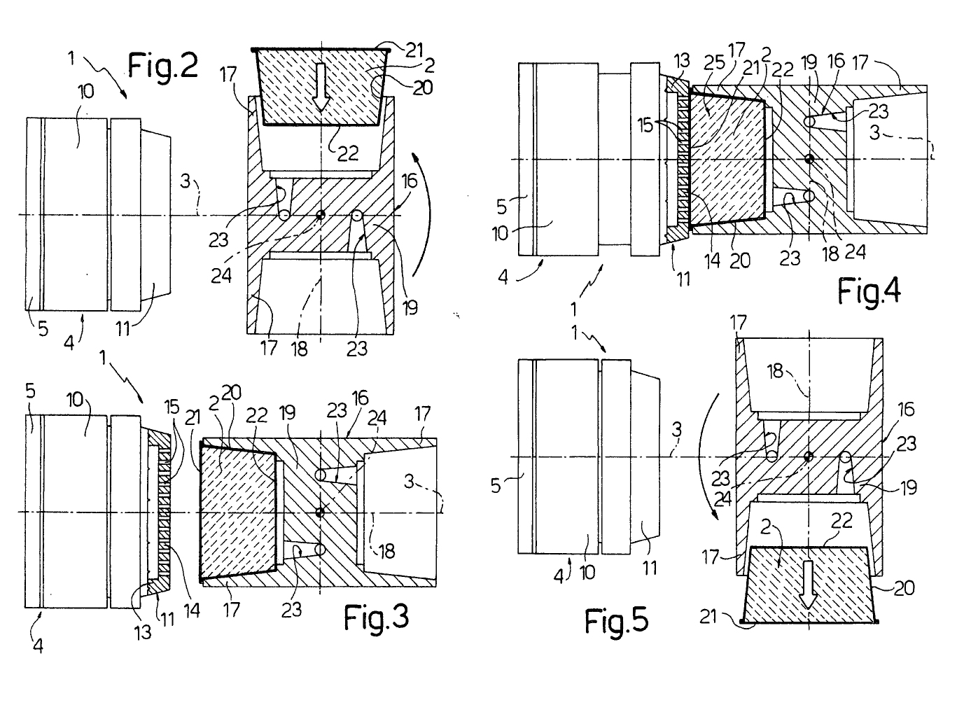

As shown in FIG. 1, machine 1 extends along a horizontal axis 3, and comprises a pressurized-hot-water dispenser assembly 4, in turn comprising a boiler 5 for receiving pressurized water drawn from a tank 7 by a pump 6. An outlet of boiler 5 is connected to tank 7 via a multiway valve 8, and is connected directly, by a conduit 9 extending through boiler 5 along axis 3, to a hydraulic cylinder 10, which forms part of assembly 4, is coaxial with axis 3, and is connected to the outlet of boiler 5 upstream from valve 8 to receive pressurized hot water from boiler 5. Assembly 4 also comprises a sprinkler 11, which receives pressurized hot water from boiler 5 via hydraulic cylinder 10 and a calibrated one-way valve 12, and is fitted, coaxially with axis 3, to a movable portion of hydraulic cylinder 10 to move (FIGS. 2 to 5), under the control of hydraulic cylinder 10 and along axis 3, between a withdrawn rest position (FIGS. 2, 3, 5) and an extracted percolating position (FIG. 4).

In the example shown, valve 8 is a two-way valve. In a variation not shown, however, comprising a steam outlet conduit in known manner, valve 8 is replaced by a three-way valve located in known manner immediately upstream from conduit 9.

In the FIG. 2-5 example, sprinkler 11 is substantially cup-shaped, is positioned with its concavity facing hydraulic cylinder 10, and is defined by a substantially cylindrical lateral wall 13, and by a front wall 14 perpendicular to axis 3 and having a number of through pressurized-hot-water outlet holes 15. In a variation not shown, front wall 14 defines the end wall of an outward-facing percolating half-chamber for partly receiving container 2.

In addition to dispenser assembly 4, machine 1 also comprises a percolating member 16 facing sprinkler 11 and in turn comprising, as shown in FIGS. 2 to 5, two opposite percolating cups 17 aligned along a longitudinal axis 18 and connected by a substantially cylindrical intermediate body 19 coaxial with axis 18. Each percolating cup 17 at least partly houses a relative container 2, which, in the example shown, is defined by a rigid capsule comprising a truncated-cone-shaped lateral wall 20 and two perforated end walls 21 and 22. Each percolating cup 17 has a respective discharge conduit 23 formed through intermediate body 19.

As shown in FIGS. 2 to 5, percolating member 16 is mounted to rotate, always in the same rotation direction (anticlockwise in FIGS. 2 to 5) and in 90° steps, about a horizontal axis 24 extending diametrically through intermediate body 19 and perpendicular to axis 3, to selectively set each percolating cup 17 to a respective loading position (FIG. 2), in which axis 18 is vertical and perpendicular to axis 3, and percolating cup 17 is positioned with its concavity facing upwards; a horizontal position (FIG. 3), in which percolating cup 17 is coaxial with axis 3 and positioned with its concavity facing sprinkler 11; and an unloading position (FIG. 5), opposite the loading position, in which percolating cup 17 is positioned with its concavity facing downwards. Percolating member 16 may be rotated in steps about axis 24 by means of a motor (not shown) or a known hand-operated click knob (not shown).

At the start of each operating cycle of machine 1, one percolating cup 17 in the loading position, after receiving a container 2 loaded downwards by gravity, rotates 90° into the horizontal position with container 2 facing sprinkler 11. At this point, pressurized water is fed by pump 6 to boiler 5, and then to hydraulic cylinder 10, to move sprinkler 11 into the extracted position (FIG. 4) in which sprinkler 11 cooperates in fluidtight manner with percolating cup 17 in the horizontal position to define, with percolating cup 17, a percolating chamber 25 housing respective container 2.

When, due to closure of percolating chamber 25, the pressure inside hydraulic cylinder 10 reaches a given value, calibrated one-way valve 12 opens so that pressurized hot water flows through container 2, and a coffee beverage flows out along relative discharge conduit 23.

When the hot water is cut off, sprinkler 11 is returned to the withdrawn position by a known elastic return member (not shown), thus opening percolating chamber 25.

Finally, further 90° rotation about axis 24 positions percolating cup 17 (FIG. 5) with its concavity facing downwards to unload the used container 2.

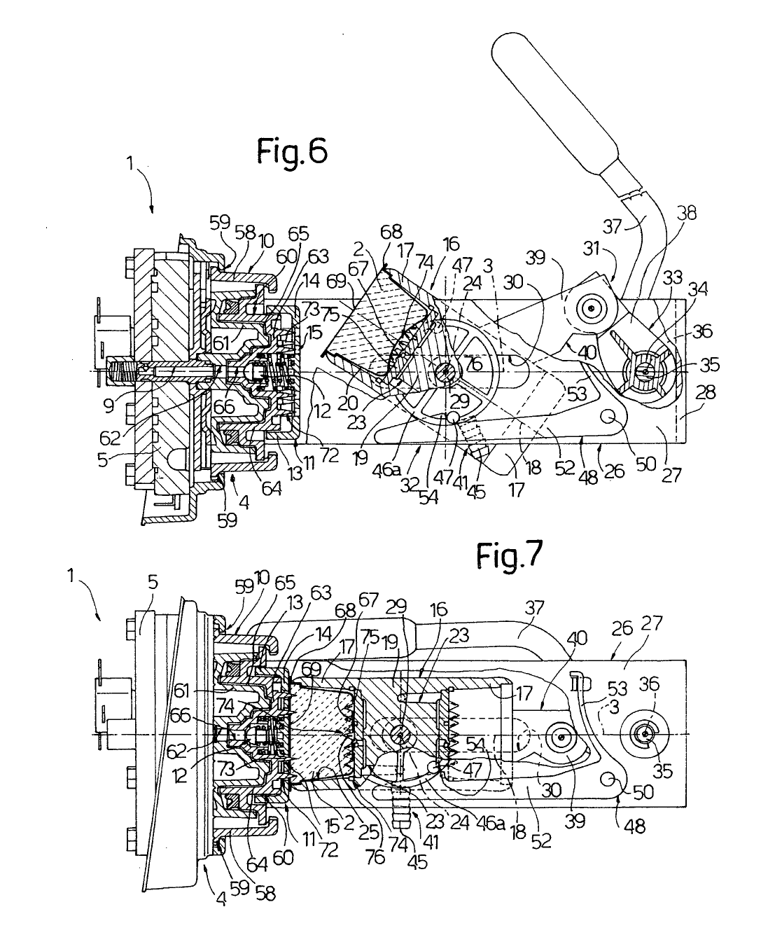

Machine 1 in FIGS. 6 to 11 comprises a frame 26 defined by two substantially rectangular plates 27, which are parallel to and located symmetrically on opposite sides of axis 3, are connected to each other at one end by assembly 4, and at the other end by a transverse wall 28, and define a gap housing percolating member 16.

Percolating member 16 comprises a shaft 29, which is integral with percolating member 16, is coaxial with axis 24, and has two opposite end portions projecting from intermediate body 19 and engaging in rotary and transversely sliding manner respective slots 30, each of which is formed, parallel to axis 3, along a central portion of a respective plate 27.

In machine 1 in FIGS. 6 to 11, percolating member 16 is step-rotated about axis 24 by translating axis 24, i.e. shaft 29, along slots 30 between a withdrawn rest position (not shown), in which percolating member 16 is located close to transverse wall 28, and a forward work position (FIG. 7), in which percolating member 16, set beforehand to the horizontal position as described later on, is positioned with the percolating cup 17 housing container 2 adjacent to and facing sprinkler 11.

The transverse movement of shaft 29 along slots 30, and the connected step-rotation, anticlockwise in FIGS. 6 and 7, of shaft 29 about axis 24, are achieved by means of a linear actuator 31, which moves percolating member 16 along axis 3 between the withdrawn rest position and forward work position described above; and a passive tipping device 32, which intercepts percolating member 16 and, as percolating member 16 moves along axis 3, applies a turning moment to it about axis 24 to selectively set percolating cups 17 to said loading, horizontal, and unloading positions.

Linear actuator 31 is a connecting rod-crank mechanism, a crank 33 of which comprises a cross member 34 extending between plates 27, located adjacent to transverse wall 28, and fitted to a pin 35, which in turn is fitted through plates 27 to rotate about a respective axis 36, parallel to axis 24, when torque is applied, for example, by a user operating an external handle 37 fitted to a free end of pin 35 projecting outwards of one of plates 27. Obviously, in a variation not shown, pin 35 is powered by a motor (not shown) fitted to one of plates 27.

Crank 33 also comprises two arms 38, each of which is adjacent to a respective plate 27 and hinged at its free end to a respective lever 39, which is hinged at its free end to a respective end of shaft 29 and defines, with the other lever 39, a double connecting rod 40 of linear actuator 31.

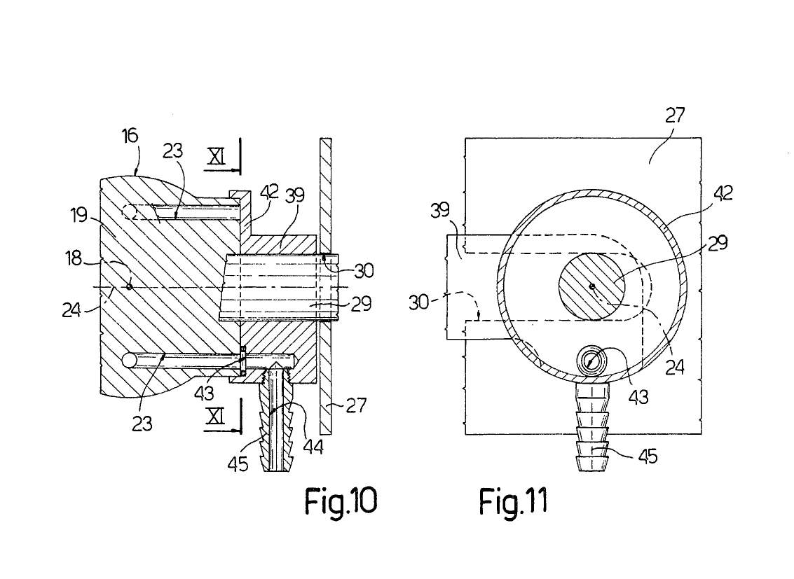

As shown in FIG. 9 and in more detail in FIGS. 10 and 11, one of the two levers 39 is fitted integrally, on the end facing percolating member 16, with a coffee discharge device 41, which is defined by a disk 42 coaxial with axis 24 and having an end surface tangent to the cylindrical lateral surface of intermediate body 19 and having an axial hole 43 defining the inlet of a discharge conduit 44 formed partly through disk 42 and relative lever 39, and partly inside a discharge fitting 45 integral with lever 39.

With reference to FIGS. 6 to 9, tipping device 32 comprises two wheels 46a and 46b, each of which is located outwards of relative plate 27, is fitted to a respective free end of shaft 29, and is fitted on its periphery with two diametrically-opposite axial pins 47 projecting towards relative plate 27. Tipping device 32 also comprises two rocker arms 48 and 49, each hinged, outwards of a respective plate 27, to oscillate about a respective pin 50, 51 parallel to axis 24. As shown in FIGS. 6 and 7, pin 50 is located close to transverse wall 28, and relative rocker arm 48 comprises a first arm 52 located beneath relative slot 30, normally in a substantially horizontal position; and a second arm defined by a leaf spring 53, a free end of which is connected in a fixed position to relative plate 27. On its free end, arm 52 has a tooth 54, which is located along the path of pins 47 of wheel 46a, and, as explained later on, is engaged by one of pins 47, as percolating member 16 moves forward from the withdrawn rest position to the forward work position, to retain wheel 46a and rotate percolating member 16 ninety degrees about axis 24, so as to move the percolating cup 17 formerly in the loading position into the horizontal position.

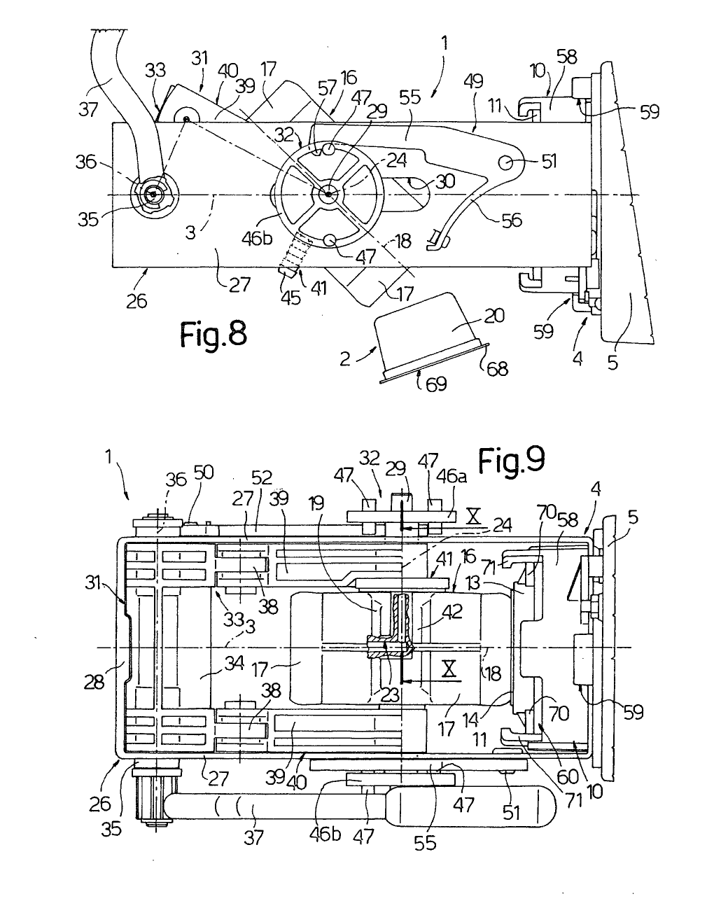

As shown in FIG. 8, pin 51 is located close to assembly 4, and relative rocker arm 49 comprises a first arm 55 located above relative slot 30, normally in a substantially horizontal position; and a second arm defined by a leaf spring 56, a free end of which is connected in a fixed position to relative plate 27. On its free end, arm 55 has a tooth 57, which is located along the path of pins 47 of wheel 46b, and, as explained later on, is engaged by one of pins 47, as percolating member 16 moves back from the forward work position to the withdrawn rest position, to retain wheel 46b and rotate percolating member 16 ninety degrees about axis 24, so as to move into the unloading position the percolating cup 17 formerly in the horizontal position facing assembly 4.

With reference to FIGS. 6 and 7, hydraulic cylinder 10 comprises a cylindrical fixed member 58 fitted integrally to boiler 5 by two removable bayonet joints 59; and a piston 60 supporting sprinkler 11 and movable with respect to fixed member 58.

Fixed member 58 is substantially cup-shaped and defined by a cylindrical lateral wall coaxial with axis 3; an end wall facing a front surface of boiler 5; and a tubular appendix 61 projecting, coaxially with axis 3, inwards of frame 26 from the end wall of fixed member 58, and having a central through hole 62 coaxial with axis 3 and communicating, at the end facing boiler 5, with the end of conduit 9.

Piston 60 is substantially cup-shaped, and comprises a front wall 63 facing sprinkler 11; and a cylindrical lateral wall 64 fitted in axially-sliding manner to the outer cylindrical surface of tubular appendix 61 to define, between its own inner cylindrical surface and the outer cylindrical surface of tubular appendix 61, a variable-volume chamber 65 communicating centrally with conduit 9 via hole 62.

As shown in FIGS. 6 and 7, piston 60 comprises a central hole 66, which is coaxial with axis 3, communicates with conduit 9 via chamber 65 and hole 62, and has a wider front portion defining a seat for a shutter body of calibrated one-way valve 12, which controls pressurized-hot-water flow from hydraulic cylinder 10 to sprinkler 11, and is calibrated, as stated, to only open when the pressure inside chamber 65 reaches a given value.

When machine 1 employs containers 2 permeable to water, sprinkler 11 is integral with piston 60.

Machine 1 may be used, however, as in the FIG. 6-11 example, for producing a beverage from a container 2 defined by a sealed capsule, in which the truncated-cone-shaped lateral wall 20 is closed at its minor base by an inwardly convex end wall 67 of thermoplastic material, and is closed at its major base, having an outer annular flange 68, by a sealing wall 69 normally made of metal foil and which is sealed to flange 68 to seal the capsule in fluidtight manner. In this case, lateral wall 13 of sprinkler 11 engages in sliding manner lateral wall 64 of piston 60, and sprinkler 11 moves axially, in opposition to a spring compressed between piston 60 and the front wall 14 of sprinkler 11, between an extracted position, in which front wall 14 is detached from front wall 63 of piston 60, and a withdrawn position, in which front wall 14 contacts front wall 63.

As shown in FIG. 9, lateral wall 13 of sprinkler 11 comprises two circumferential ribs 70 projecting radially outwards of lateral wall 13, crosswise to axis 3, and which cooperate with respective L-shaped appendixes 71 projecting axially inwards of frame 26 from fixed member 58 to limit the extraction travel of sprinkler 11 with respect to piston 60 as sprinkler 11 moves into the extracted position.

Piston 60 is fitted integrally with a piercing device 72 comprising a number of needles 73, which are integral with front wall 63, are all located about central hole 66, project, parallel to axis 3, from front wall 63 towards sprinkler 11, and are aligned with holes 15 of sprinkler 11. The length of needles 73 and the thickness of front wall 14 of sprinkler 11 are such that, when sprinkler 11 is in the extracted position, needles 73 are located inwards with respect to respective holes 15, and, when sprinkler 11 is in the withdrawn position, needles 73 project partly outwards of wall 14 towards percolating member 16.

Machine 1 also comprises, for each percolating cup 17, a further piercing device 74, in turn comprising a plate 75 (FIGS. 6 and 7) located at the bottom of respective percolating cup 17 and having a number of needles 76, which extend parallel to axis 3 and, in use, pierce the end wall 67 of container 2, deformed outwards by the pressurized hot water fed into container 2, so that the percolated coffee flows out of container 2 and, via a number of known through holes formed through needles 76 and plate 75, into discharge conduit 23 of respective percolating cup 17.

As regards operation of machine 1 described above, it is important to note that the operating cycle of machine 1 commences with percolating member 16 in the withdrawn rest position, with axis 18 positioned vertically, and with one of percolating cups 17 facing upwards in the loading position.

When container 2 is inserted inside the percolating cup 17 in the loading position, and handle 37 is lowered by the user, shaft 29 moves along slots 30 towards boiler 5, so that one of pins 47 on wheel 46a (FIG. 6) engages tooth 54 to lock wheel 46a angularly, and shaft 29 is so torqued as to rotate percolating member 16 ninety degrees about axis 24 and move the percolating cup 17 formerly in the loading position into the horizontal position. Rotation of shaft 29 continues until pin 47 disengages tooth 54.

As shaft 29 moves further along slots 30, percolating member 16 is moved into the forward work position. Over the final portion of this movement, sprinkler 11 is brought into contact with container 2, so that sprinkler 11 moves from the extracted position to the withdrawn position, annular flange 68 of container 2 is positioned contacting the free edge of relative percolating cup 17, and needles 73 pierce sealing wall 69 and penetrate container 2.

As shown in FIGS. 9 to 11, upon percolating member 16 reaching the forward work position, linear actuator 31 is set to a dead centre position with levers 39 aligned with respective arms 38, and the outlet of discharge conduit 23 of the percolating cup 17 housing container 2 is aligned with hole 43 in disk 42, so that discharge conduit 23 communicates directly with discharge conduit 44 of discharge device 41.

Obviously, if container 2 is permeable to water, as opposed to a sealed capsule, sprinkler 11, as stated, is integral with piston 60, and, when linear actuator 31 reaches the dead centre position, container 2 is positioned substantially contacting sprinkler 11, and is only pressed in fluidtight manner against sprinkler 11 by subsequent movement of piston 60.

At this point, pressurized hot water is fed along conduit 9, thus expanding chamber 65 and pushing piston 60, and therefore sprinkler 11, against percolating cup 17, so that annular flange 68 is gripped between sprinkler 11 and the free edge of percolating cup 17 to define percolating chamber 25. Once sprinkler 11 is connected in fluidtight manner to percolating cup 17, the pressure inside chamber 65 increases sharply, so that calibrated one-way valve 12 opens, pressurized hot water flows into container 2, end wall 67 is deformed outwards so that needles 76 penetrate container 2, and the percolated beverage flows out through needles 76, plate 75, discharge conduit 23, and discharge conduit 44 of discharge device 41.

Once one coffee is prepared, to prepare another coffee or simply remove the used container 2 from machine 1, the user operates handle 37 to rotate crank 33 in the opposite to forward movement direction, and at the same time move shaft 29 along slots 30 towards transverse wall 28.

As shown in FIG. 8, during this movement, one of pins 47 on wheel 46b engages tooth 57 to lock wheel 46b angularly. The opposition between pin 47 and tooth 57 rotates percolating member 16 ninety degrees about axis 24, in the same direction as for the forward movement, so that the percolating cup 17 formerly in the horizontal position facing sprinkler 11 is set to the unloading position, and the used container 2 drops out.

As shaft 29 moves further along axis 3, percolating member 16 is set to the withdrawn rest position with the percolating cup 17, which was idle in the previous cycle, set to the loading position ready to receive another container 2.

1. A machine for percolating a beverage from powdered material in a container (2), the machine (1) comprising pressurized-hot-water dispensing means (4) having a first axis (3), which is a horizontal axis; a percolating member (16) facing the hot-water dispensing means (4) and comprising two opposite percolating cups (17) for housing respective said containers (2); first actuating means (10) for moving the pressurized-hot-water dispensing means (4) along the first horizontal axis (3) and to and from a fluidtight engaged position with the percolating member (16) to define a percolating chamber (25) therewith; second actuating means (31, 32) for rotating the percolating member (16) about a second axis (24), which is a horizontal axis perpendicular to the first axis (3), so as to selectively position each percolating cup (17) in a first loading position in which said percolating cup (17) faces vertically upwards, in a second position in which said percolating cup (17) is coaxial with the first axis (3) and can be set to said fluidtight engaged position, and in a third unloading position in which said percolating cup (17) faces downwards; and discharge means (23, 41) communicating with the percolating chamber (25) to expel said beverage; the machine (1) being characterized in that the second axis (24) is movable with the percolating member (16) along the first axis (3) to and from a work position; push means (31) being provided for moving the percolating member (16) along the first horizontal axis (3).

2. A machine as claimed in claim 1, wherein said push means (31) form part of the second actuating means (31, 32), which further comprise retaining means (32) for engaging the percolating member (16) to rotate it about the second axis (24) when the second axis (24) is moved along the first axis (3) by the push means (31).

3. A machine as claimed in claim 1, wherein the second actuating means (31, 32) are designed to rotate the percolating member (16) about the second axis (24) always in the same rotation direction.

4. A machine as claimed in claim 1, wherein the pressurized-hot-water dispensing means (4) comprise an output sprinkler (11); and the first actuating means (10) are fitted to the sprinkler (11) to move the sprinkler (11) along the first axis (3) and to and from said fluidtight engaged position engaging a said percolating cup (17) arranged in said second position on the percolating member (16) arranged in said work position.

5. A machine as claimed in claim 1, wherein said first actuating means (10) are hydraulic actuating means.

6. A machine as claimed in claim 4, wherein said first actuating means (10) are located in series with the sprinkler (11), receive said pressurized hot water, and communicate with the sprinkler (11); a calibrated one-way valve (12) being interposed between the first actuating means (10) and the sprinkler (11).

7. A machine as claimed in claim 4, wherein, in addition to the sprinkler (11), said pressurized-hot-water dispensing means (4) comprise a hydraulic cylinder (10), in turn comprising a movable member (60) movable along the first axis (3), and a fixed member (58), which between them define a variable-volume chamber (65); a boiler (5) communicating with said variable-volume chamber (65); and a calibrated one-way valve (12) interposed between said variable-volume chamber (65) and the sprinkler (11), which is supported by the movable member (60); the hydraulic cylinder (10) moving the sprinkler (11) to and from said fluidtight engaged position engaging a said percolating cup (17) in said second position.

8. A machine as claimed in claim 3, wherein said push means (31) cause the percolating member (16) to perform a succession of operating cycles, each of which comprises a forward movement into said work position, and a return movement into a withdrawn rest position; said retaining means (32) being linked to the push means (31) to rotate the percolating member (16) ninety degrees about the second axis (24) and in said rotation direction in response to performance of each said movement by the percolating member (16), so that, by the end of a said operating cycle, a said percolating cup (17) formerly in said first position is set to said third position.

9. A machine as claimed in claim 7, and comprising a frame (26), in turn comprising guide means (30) for guiding the percolating member (16) to and from said work position.

10. A machine as claimed in claim 9, wherein the percolating member (16) comprises a shaft (29) located between said percolating cups (17) and coaxial with the second axis (24); said guide means (30) extending parallel to said first axis (3), and being engaged in rotary and transversely-sliding manner by said shaft (29).

11. A machine as claimed in claim 2, and comprising a frame (26) supporting said percolating member (16), which comprises a shaft (29) located between said percolating cups (17), coaxial with the second axis (24), and fitted in rotary and transversely-sliding manner to the frame (26); said retaining means (32) comprising a tipping device (46a, 46b) fitted to said shaft (29), and contrasting means (48, 49) carried by the frame (26) and engaged by the tipping device (46a, 46b), during each said movement, to rotate the percolating member (16) ninety degrees about the second axis (24) and in said rotation direction.

12. A machine as claimed in claim 11, wherein said tipping device (46a, 46b) comprises two first pins (47) parallel to the second axis (24), integral with said shaft (29), located symmetrically with respect to the shaft (29), and each associated with a relative said percolating cup (17); and two second pins (47) parallel to the second axis (24), integral with said shaft (29), located symmetrically with respect to the shaft (29), and each associated with a relative said percolating cup (17); and said contrasting means (48, 49) comprise a first and a second elastically deformable tooth (54, 57) carried by said frame (26); said first tooth (54) being located along a path traveled, during said forward movement, by that of said first pins (47) associated with the percolating cup (17) initially in the first position; and said second tooth (57) being located along a path traveled, during said return movement, by that of said second pins (47) associated with the percolating cup (17) in the second position at the start of the return movement.

13. A machine as claimed in claim 11, wherein said push means (31) comprise a crank mechanism (31) supported by said frame (26) and in turn comprising a crank (33) fitted to the frame (26) to oscillate, with respect to the frame (26), about a third axis (36) parallel to the second axis (24), and a connecting rod (40) interposed between the crank (33) and said shaft (29); the connecting rod (40) being set to a dead centre position aligned with the crank (33) along the first axis (3), when the percolating member (16) is in the work position.

14. A machine as claimed in claim 13, wherein said push means (31) also comprise a hand-operated lever (37) extending from said third axis (36) and integral with said crank (33).

15. A machine as claimed in claim 1, wherein said discharge means (23, 41) comprise, for each said percolating cup (17), a discharge conduit (23) formed in said percolating member (16) and for discharging said beverage.

16. A machine as claimed in claims 13, wherein said discharge means (23, 41) also comprise an outlet manifold device (42) integral with said connecting rod (40), and which, when said connecting rod (40) is in said dead centre position, cooperates in fluidtight manner with an outlet of the discharge conduit (23) of that of the percolating cups (17) which is in the fluidtight engaged position, to expel said beverage.

17. A machine as claimed in claim 15, wherein the percolating member (16) comprises an intermediate body (19) interposed between the two percolating cups (17), the discharge conduit (23) of each percolating cup (17) being formed through said intermediate body (19).

18. A machine as claimed in claim 1, and for making a beverage from a sealed container (2) containing a powdered material and defined by a cup-shaped body comprising an end wall (67) and closed by a sealing wall (69); the machine (1) comprising piercing means (72, 74) for penetrating a sealed said container (2), housed inside a respective percolating cup (17), through said sealing wall (69) and said end wall (67).

19. A machine as claimed in claim 18, wherein said piercing means (72, 74) comprise a first piercing device (72) having needles (73) and carried by said pressurized-hot-water dispensing means (4) to feed pressurized hot water through said sealing wall (69); and a second piercing device (74) having needles (76) and housed inside each percolating cup (17) to extract said beverage from a relative said container (2) through said end wall (67).

20. A machine as claimed in claim 6, wherein said sprinkler (11) is fitted movably to said movable member (60) to move, along the first axis (3), between an extracted position covering the needles (73) of the first piercing device (72), and a withdrawn position in which the needles (73) project outwards of the sprinkler (11).
